(19) United States
(12) Patent Application Publication
(10) Pub. No.: US 2026/0304266 A1
(43) Pub. Date: Oct. 1, 2026

(54) Detection of Terminals Embedded in Devices in Flight, Such As Drones

(71) Applicant: ORANGE, Issy-les-Moulineaux (FR)

(72) Inventors: Benoit RADIER, CHATILLON CEDEX (FR); Gaël FROMENTOUX, CHATILLON CEDEX (FR); Fanny PARZYSZ, CHATILLON CEDEX (FR); Xavier MARJOU, CHATILLON CEDEX (FR)

(21) Appl. No.: 19/483,336

(22) PCT Filed: May 7, 2024
(86) PCT No.: PCT/EP2024/062655

§ 371 Date: Nov. 11, 2025

(30) Foreign Application Priority Data
May 12, 2023 (FR) FR2304706

(51) Int. Cl. H04W 36/08; H04B 17/318; H04W 64/00; H04W 84/06

(52) U.S. Cl. CPC H04W 36/08; H04B 17/318; H04W 64/00; H04W 84/06

(57) ABSTRACT

A detection of a terminal which could be embedded in a device in flight, where the terminal is connected to a mobile network having a plurality of cells covered by respective antennas. The detection includes: obtaining current connection data from the terminal at successive cells of the mobile network, the current data including at least cellular data involved in the connection of the terminal to the mobile network; comparing current data to terrestrial terminal connection reference data and having at least one cell of the current data get involved; and as a function of the comparison, determining whether the terminal is embedded in a device in flight.

### TECHNICAL FIELD

The present disclosure relates to the field of the detection of devices in flight such as drones.

### DESCRIPTION OF RELATED ART

Typically, drones have embedded terminals, called “aerial terminals” below. An aerial terminal may serve to transmit a flow of video data (acquired for example by a camera embedded in the drone) via a mobile network to which the aerial terminal is connected. It may also serve to directly pilot the drone by transmitting instructions received from another terminal available to a user, pilot of the drone. Thus, in these various situations, an aerial terminal is connected to a network, for example a mobile cellular network.

Detecting the drone to verify specifically whether it is authorized to fly often requires a complex installation of radiofrequency sensors, and/or radar, and/or means for implementing detection of radiofrequency beacons which the drone broadcasts, where this broadcast is called “ADS-B” (for Automatic Dependent Surveillance-Broadcast).

Drone operators may use mass-market mobile terminals connected to a mobile network for controlling their drones. However, a drone must have a flight plan to be authorized to fly over a zone. Further, a valid license to fly must be issued to the drone operator. Otherwise, the drone operator may be subject to a fine and revocation of their license. Just the same, to do that, the drone must be detected and the identity of the drone operator determined.

Further, a malicious drone user may have deactivated the aforementioned beacons for the ADS-B broadcast.

One approach may consist of relying on a mobile cellular network for detecting the presence of an aerial terminal. However, cellular networks, designed for transmissions from terrestrial terminals, are not optimized for aerial connectivity. An aerial terminal (called “drone” below by extension) may connect to secondary lobes of antennas near the drone or to primary lobes far from the drone. The consequence of this is that mobile modems used for connecting the drones are not necessarily identified as being “drone” type, which complicates the detection of actual drones.

Further, the identity of an owner of the drone, used by a pilot who may be very far away (“Beyond Visible Line of Sight,” for example), may be unknown. Similarly, the identity of a pilot who uses a drone flying within sight and who directly broadcasts, via a mobile network over the Internet, for example, data for images captured by the drone, may be unknown.

### BRIEF SUMMARY OF THE INVENTION

The present disclosure aims to improve the situation.

For this purpose, it proposes a method for detection of a terminal which could be embedded in a device in flight (typically a drone, but possibly an ultralight motorized plane or other). The terminal is connected to a mobile network comprising a plurality of cells covered by respective antennas (typically base stations in a conventional cellular network), but also possibly Wi-Fi hotspots (for example Wi-Fi relay gateways), or other.

In particular, this method comprises:
obtaining current connection data from the terminal at successive cells of the mobile network, where said current data comprises at least cellular data involved in the connection of the terminal to the mobile network;
comparing current data to terrestrial terminal connection reference data and having at least one cell of said current data get involved; and
as a function of said comparison, determining whether the terminal is embedded in a device in flight.

These reference data may correspond to terrestrial terminal connection data or the theoretical connection values specific to a conventional terrestrial terminal moving on the ground (conforming to a diagram for example). In fact, as detailed later with reference to FIGS. 1 and 2, the connectivity to the cellular network of the terminal in-flight is different from the conventional connectivity of a terminal on the ground. For example, the connection to base stations in connection transfer situations (handovers) was observed as being different for a terminal in-flight and for a terrestrial terminal in motion.

Thus, here it is proposed to analyze the data returned by mobile networks for detecting in particular undeclared drones and embedded terminals using cellular connectivity for broadcasting media flows (in particular image, video and/or audio data) and/or to use piloting data.

In an embodiment making use of the aforementioned handover situations, the method may comprise:
obtaining current data for connection transfer of the terminal from one cell to another cell, where said current data comprises at least data from cells involved in said transfers; and
comparing current data to terrestrial terminal connection transfer reference data and having at least one cell of said current data get involved.

In particular, if two cells of the network are deemed to be adjacent because they provide a connection transfer for a terrestrial terminal from one of the two cells to the other, then said data comparison may comprise the detection in the current data of a connection transfer between two cells which are not deemed to be adjacent.

It will be thus understood that the detection of a handover between two cells, which is never done for a terrestrial terminal may characterize the presence of a terminal in-flight.

In such an implementation, if the current data further comprise the respective moments of these transfers, then the current data may be analyzed to detect whether the terminal connects several times successively to two cells which are not deemed to be adjacent and in a time interval less than a threshold (this situation is hereafter called “ping-ponging” between two cells).

Alternatively or additionally, in this implementation, if the current data further comprise respective moments of transfers, the current data may be analyzed for detecting whether a trajectory which the terminal follows passes by successive cells which are not deemed to be adjacent.

Thus, the trajectory of the terminal in-flight may be determined by the handover situations.

Just the same, alternatively or as a variant of the detection of the handovers, the current data may in particular comprise radiofrequency connection link strength data for the terminal with each of the aforementioned successive cells of the mobile network, in order to estimate successive positions of the terminal (possibly but optionally in 3D coordinates).

Here, “link strength” is understood, generically, as any physical parameter characterizing this link (intensity or power, or even signal-to-noise ratio, of the radiofrequency connection).

Thus, by the determination of the successive positions occupied by the terminal, it is possible to determine the trajectory thereof.

In the embodiment using handover data or the embodiment using radiofrequency link strength, the current data may then further comprise respective moments of connection to said successive cells, and the aforementioned current data may be analyzed to determine a trajectory of the terminal and detect for example whether a velocity of movement of the terminal over this trajectory is greater than a threshold.

For the study of the aforementioned radiofrequency link strength, an entity of the mobile network may perform a GMLC type function, Gateway Mobile Location Center (whose references are given in detail later).

Alternatively or additionally, the study of the connections of the terminal to successive cells, in particular in handover situation, may be implemented by an entity of the network executing in NWDAF type function, Network Data Analytic Function (detailed later).

The entity in the network which could implement such functions is typically the Core Network, or even an entity dedicated to this aerial terminal detection application and connected to the Core Network, as presented later with reference to FIG. 4.

In an implementation, the aforementioned current data may typically comprise at least one identifier for the terminal and at least one user identifier for the terminal.

In fact, once the data generated by the network (Core Network) are accessible, the identifiers of the terminal and the identity of the user thereof are also accessible.

In an embodiment, it is then possible to:
consult a platform (for example “USS” type, as detailed below) for records of pilots and/or flight plans of devices with onboard terminals; and
determine at least whether the user identifier of the terminal is declared among said records from the platform.

It is further possible to:
consult this platform for determining whether at least the trajectory of the terminal conforms to a flight plan declared for said terminal, and/or also to
verify whether the detected trajectory includes at least one sensitive site, associated with restrictive overflight conditions (which had not been authorized for example by an administration managing this sensitive site).

Other examples of control may be taken, in particular for checking whether the moment of overflight of the site was in an authorized period or not (for example because of a one-time event). The following detailed description gives details of these various examples.

The present disclosure also aims at a computer program comprising instructions for implementing the method according to the present, when they are executed by a processing circuit. According to another aspect, a nonvolatile recording medium, on which such a program is recorded, readable by a processing circuit, is proposed.

The present disclosure also aims at a device comprising a processing circuit for implementing the above method.

This device may typically comprise a connection to a mobile core network, on the one hand, and to a platform of the aforementioned type, for registration of pilots and/or flight plans for devices with onboard terminals, on the other.

Such a device may then be set up for executing at least one NWDAF type function (Network Data Analytic Function) and one function of GMLC (Gateway Mobile Location Center).

This function type interfaces advantageously with an NEF type function (Network Exposition Function) which implements a USS type gateway.

Thus, the device may be arranged for executing said NWDAF or GMLC type function in connection with the USS platform via such an NEF type function.

### BRIEF DESCRIPTION OF THE DRAWINGS

Other characteristics, details and advantages will appear upon reading the following detailed description and upon analysis of the attached drawings, on which:

FIG. 1 shows a connection example for a terminal embedded in a device in flight.

FIG. 2 shows an example of connections of the embedded terminal B to successive antennas of the cellular mobile network, for comparison with the usual connections of a terminal A, on the ground.

FIG. 3 shows an example of a method in the meaning of the present disclosure, according to an embodiment.

FIG. 4 shows an example of a system including a device SER in the meaning of the present disclosure, according to an embodiment.

### DETAILED DESCRIPTION OF THE INVENTION

Hereafter, “normal terminal” is understood to mean conventional, terrestrial terminal. It is noted UE_A (for User Equipment (UE) terrestrial), and it is assumed to be connected to the antenna of a base station with direct visibility of the terminal on the ground. A conventional terminal is for example a smart phone type terminal or an IOT (Internet of Things) type terminal.

In contrast, an “abnormal terminal” is understood below as a terminal embedded in “aerial” equipment. It is noted UE_B. Being embedded in equipment at altitude, the UE_B terminal does not necessarily connect to the typical closest antenna for a terminal on the ground but may connect to cells much farther away because the secondary lobe of the closest antenna emits less, for the abnormal terminal, than a distant antenna that the normal terminal could not see.

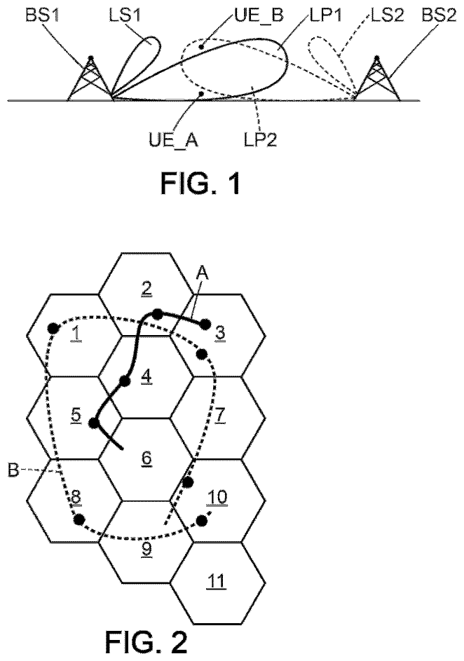

This situation is shown on the example from FIG. 1, where a terminal in-flight UE_B is covered by the primary lobe LP2 (in dotted lines) of an antenna here of a more distant base station BS2, whereas on the ground it would've been covered by the main lobe LP1 (in solid lines) of the closest station BS1, as is the situation for a normal terminal UE_A. The secondary lobe(s) LS1 of the closest base station BS1 is (are) not sufficient to cover the terminal UE_B in-flight, such that it naturally connects to the station BS2 even if it is farther than the station BS1 for the terminal UE_B.

One embodiment of the present disclosure proposes to make use of this observation for detecting embedded terminals, in particular embedded in drones.

The analysis of connections to base stations of the cellular network (or more generally “antennas” below) makes it possible to study in particular the trajectories of terminals (as well as effects called “ping-ponging” and the displacement speeds of terminals, as will be seen later).

In the present embodiment, detecting trajectories which do not correspond to a normal trajectory for a normal UE_A terrestrial terminal is proposed.

For example, referring to FIG. 2, the list of antennas used for connecting a terminal is collected during mobility procedures, also called transfers, between antennas (called “handover” for passing from a cell covered by one station to a cell covered by another station). This list of antennas defines a trajectory as shown in FIG. 2, with, in particular:
for the terminal UE_A, for the trajectory A defined by 3, t1; 2, t2; 3, t3; 2, t4; 4, t5; 5, t6, and
for the terminal UT_B, the trajectory B is defined by 10, t1; 3, t2; 10, t3; 3, t4; 1, t5; 8, t6; 10, t7.

It thus appears that the trajectory B shows the use of cells which are not necessarily “adjacent” (in the sense of their typical use for “normal” terminals on the ground) during handovers, which thus allows detecting an anomaly characteristic of embedding the UE_B terminal in a flying machine.

Thus, the analysis of the control data from the mobile network between each antenna used and the mobile core network via probes may allow, under certain circumstances, analyzing the movement of abnormal terminals.

The control of the mobile network (or CDR) makes it possible to get accounting data necessary for billing, in particular. The CDR may be generated by analyzing the signaling, for example, over S1 interfaces towards the core network between the base stations or “eNodeB” of the network and the gateway S-GW (Serving Gateway) or the manager MME (Mobility Management Entity) near the mobile core network, with the use of probes.

The signaling between the MME manager and the eNodeB contains information about cell identifier, terminal identity IMEI, session identity @IP and identity of the use (USIM/ISIM). Thus, from the set of cells used for connecting a terminal, it is possible to reconstitute the trajectory of the vehicle with the embedded terminal. The signaling data may thus provide information such as the identity of the terminal, the name of the operator, the connection date, the identifiers of the cells (current or previous) which were used for connecting the terminal, the service type, etc.

The analysis of the signaling data (control plane, transfer plane) may be done in an NWDAF (Network Data Analytic Function, according to the standard TS 23.288) type function or in a management plane with the MDAF (Management Data Analytic Function, according to the standard TS 28.533, for the 5G network) function. The MDAF, NWDAF 5G functions may also collect the desired data from the functions of the control plane and the transfer plane of the 5G network without passing by probes. The inventory of the locations of the antennas at given moments makes it possible to have information about the distance traveled between cells and the geographic zone which was overflown. Each antenna may be identified with longitude and latitude information.

Enriching a function of this NWDAF type is thus proposed for analyzing the trajectories of the terminals, based on a list of antennas to which the terminal was connected with the associated connection dates, where this list was drawn from the analysis of the signaling data of the mobile network.

In this context, a service proposing detecting abnormal behaviors of terminals may be created in order to detect abnormal mobile trajectories. This detection may be reported to an application having:
subscribed to the “abnormal behavior” service; and
requested the trajectory statistics or predictions over a given zone and a given time, the list of the terminal types or the identities of terminals with abnormal behavior (@IP, IMEI, IMSI, name-first name, etc.).

Such a service may offer tools such as:
“Unexpected UE location” (detection of an unexpected position of the terminal);
“Ping-ponging across neighboring cells” (exchanges between cells assumed to be neighboring in particular for a handover);
“Unexpected wakeup” (unexpected appearance of a terminal at a given cell);
“Unexpected radio link failures” (unexpected interruption of a radio link with a cell).

The following table gives (left column) a more exhaustive list of the possible tools and (right column) the description of the pre-existing, standardized parameters with which to implement these tools.

| | Terminal Behavior Parameters |
|---|---|
| Incident Identifiers | to Be Provided |
| Unexpected UE location | Expected UE Moving Trajectory |
| | Stationary Indication |
| Unexpected long-live/large rate | Periodic Time |
| flows | Scheduled Communication Time |
| | Communication Duration Time |
| Unexpected wakeup | Periodic Time |
| | Communication Duration Time |
| | Scheduled Communication Time |
| Suspicion of DDOS attack | Periodic Time |
| | Communication Duration Time |
| | Scheduled Communication Time |
| | Scheduled Communication Type |
| | Traffic Profile |
| | Expected transaction Dispersion |
| Too frequent Service Access | Periodic Time |
| Unexpected radio link failures | Expected UE Moving Trajectory |
| Ping-ponging across | Expected UE Moving Trajectory |
| neighboring cells | Stationary Indication |

The implementation of an NWDAF type function makes it possible to access these parameters (right column), and from there, by an enrichment in the meaning of the present disclosure of this function, to access incident detections (left column) characterizing the presence of a terminal embedded in a flying device such as a drone.

As a variant or in addition (for strengthening the trajectory determination), a GMLC type localization function (Gateway Mobile Location Center—as presented in particular in the document TS 29.515 V18.1.0 (2023 March) from 3GPP) may also be used. Such a function determines the current position of the terminal more finely by relying on the power measurement of the radiofrequency link with neighboring antennas. The determination of the position of the terminal is then done by triangulation.

More generally for an MDAF, NWDAF or GMLC type function, the collection of data may be done over existing mobile networks and for all terminals, usually in order to generate billing tickets. This collection is implemented for regulatory needs (emergency service, or other). With the 5G standard, the collection may be done on request and for a given zone for any terminal.

These data may then be analyzed to determine an identity of the terminal, as well as an identity of its user. It may typically be verified whether the user declared themself with an aerial surveillance authority for piloting a drone and, as applicable, whether they declared a flight plan with this authority conforming to the observed trajectory for this drone by implementing the aforementioned analysis function (for example NWDAF). Further, in addition or as a variant, it may also be verified whether the flight plan type itself conforms to a prior declaration of its pilot. For example, a high-altitude flight (whatever the precise trajectory of the drone) in particular for police and/or military surveillance applications may be detected by an analysis function (for example, NWDAF) if a level of abnormal behaviors (for example a level of connections to unusual cells, in particular in handover situation) is over a first threshold THR1. On the other hand, a lower altitude flight, particularly for merchandise or other delivery applications, may be characterized by a rate of abnormal behaviors included between the first threshold THR1 and a second threshold THR2 below the threshold THR1, and below which the terminal could be qualified as terrestrial, for example.

In an embodiment, this analysis function (for example, NWDAF and/or even GMLC) may interface with a USS type platform (for “UAS Service Supplier”, “UAS” for “UAV System” and “UAV” for “Unmanned Aerial Vehicle”). It involves a service provider for drone systems (such systems comprising drones and infrastructure for controlling them). Such a USS platform manages the use of the airspace by providing services to the operator and/or the pilot of a drone to satisfy the operational requirements of a drone manager called UTM (Uncrewed Aerial System Traffic Management).

The interfacing between the NWDAF type analysis function and the USS then makes it possible to verify whether the service subscription conditions of a third party are met, and otherwise to alert an authority which wishes to detect drones in a given space-time or to detect and identify drones which are not declared or which flyover an unauthorized zone, or other.

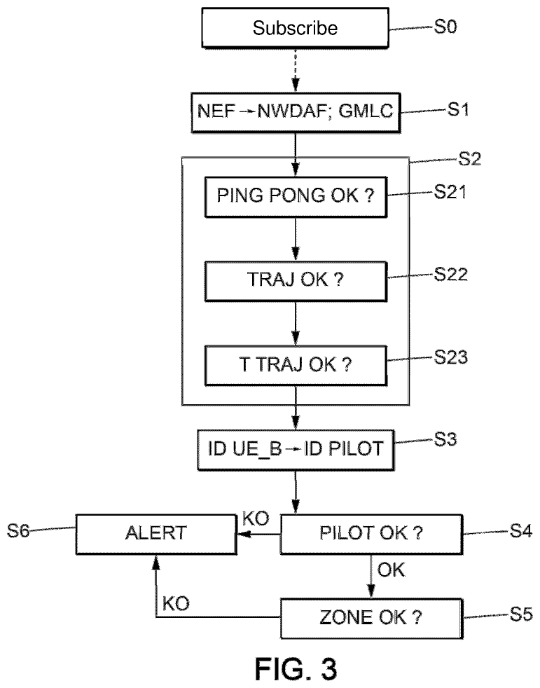

Now refer to FIG. 3 showing a possible form of a method in the meaning of the present disclosure.

Analyzing the data from the control plane of mobile networks for at least one of the following actions is proposed:
detecting drones connected to the mobile network;
identifying that a terminal is potentially a drone, UAV (Unmanned Aerial Vehicle, therefore an aerial vehicle with no human on board, typically a drone);
detecting the noncompliant behaviors of the drone relative to the flight parameters declared for this drone;
finding the identity of the drone operator (for example the pilot) who controls equipment identified as being “UAV” type via a service subscription profile associated with this equipment;
issuing notifications to aerial security services that a drone not using an aerial service managed by a USS was detected, and potentially that this drone is arriving or was detected in an unauthorized flight zone or a zone requiring a specific subscription.

For example, a subscriber to such a drone detection service may be an entity connected with the USS and imposing surveillance of a given airspace (for example a sensitive site, such as a military or nuclear site, a prison, or other) or even an entity in charge of some aerial corridors (in particular for civil aviation).

Thus, the pilot of a drone may declare a step S0 of subscription, via an application function, to a aerial control service managed by one or more USS entities in connection with one or more authorities, such as a civil aviation division for a given country, one or more players in charge of security for sensitive sites (nuclear plants, prisons, etc.). The USS platform (or finally the pilot via the USS) may further declare the association between the drone, the identity of the pilot and the authorized flight zones with a mobile network operator (called NEF for Network Exposition Function). During the flight of such a declared drone, the aforementioned NWDAF function may then interface with the USS, more specifically via this NEF type function, in order to identify for example whether the drone is crossing into an unauthorized zone.

More generally, the players calling on the USS may wish to:
locate undeclared drones by subscription to a service from a mobile network operator; and
locate drones which could be declared but are flying over sensitive sites (for example by default around an airport if alone among these players is a civil aviation division).

The USS, via the NEF function, then calls on an NWDAF type function (Network Data Analytic Function) for the drone detection service, which may then operate:
in a given 3D geographic zone, and possibly
during a given time (for an event such as a festival for example).

Then referring to FIG. 3, after this initial step S0 of service declaration and subscription, during a step S1 of ongoing implementation of the service, the NEF function calls on data from an NWDAF type function to get the abnormal terminal behaviors, i.e. abnormal for terrestrial terminals and possibly corresponding to drone behaviors (or to a terminal in a drone) in a current geographic zone. This operation allows getting a list of antennas called on or directly getting the geographic coordinates of each terminal with the erratic behavior during a given time interval, as detailed below.

An entity of the network such as the Core Network may then implement the NWDAF function in the general following step S2 by collecting the data from the mobile network and analyzing the abnormal terminal behaviors. At least one of the test operations below may be implemented for this purpose.

A first possible operation S21 proposes analyzing the probability of the effects called “ping-ponging” when the terminals connect several times to neighboring antennas during a very short time interval (typically under 5 seconds). This situation may be detected because the terminal connects to antennas having the same identifiers several times in a short time interval. For example, the ping-ponging effect sequence for a normal terrestrial terminal UE_A (3:2:3:2), which is nearly static, may allow identification of an abnormal behavior with the following sequence from the terminal in-flight UE_B (10:3:10:3). In fact, the probability of finding ping-ponging effects with the antennas 3:10 is low, even zero, for a terrestrial terminal. Further, the distance between the antennas 3 and 10 is greater than the ping-ponging distances for terrestrial terminals in this area. The terrestrial terminal cannot, in principle, connect to two antennas 10 and 3 in a short span of time (under 5 seconds typically). The distance between the antennas is analyzed with the coordinates of different antennas from the mobile network.

A second possible operation S22 proposes comparing a current trajectory with the analyzed trajectory probabilities for terrestrial terminals (where a normal trajectory is 3:2:3:2:4:5 in the example from FIG. 2). A terminal which gets a trajectory outside of the probabilities specific to the terrestrial terminals may fall in the category of “probably aerial terminals.” This abnormal trajectory probability is identified in operation S22 as abnormal because the probability that a terminal passes from antenna 10 to antenna 3 is very low and, similarly, between the antennas 8 and 10 (10:3:10:3:1:8:10). The probability that a trajectory is probably aerial may be validated/confirmed by analyzing the distance between the antennas. For example, if the distance between the antennas 8 and 10 is greater than 20 km, this sequence of antennas is improbable for a terrestrial terminal and taking it characterizes the trajectory of the drone.

A third possible operation S23 proposes analyzing the velocity of the terminals by estimating the distances traveled between nonadjacent cells (10:3:1:8:10). Such an operation also serves to improve drone detection predictions, which do not have, in principle, the same displacement velocities as terrestrial terminals (pedestrians, bicyclists, automobiles, often on roads with high traffic density, etc.), since the displacement velocity of a drone is generally larger.

Thus, implementation of the NWDAF function allows obtaining, after implementing the general step S2, a list of terminals with associated probabilities that they are embedded in respective drones, by observation of abnormal ping-ponging, and/or abnormal trajectory (from handovers), and/or abnormal velocity (for a terrestrial terminal). This list may be supplied to the aerial controller with the identifiers of the terminals having such an abnormal behavior, together with information on the identity of the respective owners of the subscriptions to the network (in particular in the case where this aerial control authority may already have such information on the users, like for example police with aerial regulation authority, civil security, or other).

Thus, these three types of analysis may be added to the usual analysis services for which the NWDAF function is already responsible:
detecting an abnormal ping-ponging S21 (repetitive mobility towards identical antennas in a very short time span, for example under a threshold of 5 seconds or less);
detecting an abnormal trajectory S22 (sequence of antennas providing successive handovers having a very small probability compared to a set of terminal trajectories deemed to be terrestrial); and
detecting an abnormal speed of the terminal S23 (characterized by a distance traveled, according to the handovers reported by the antennas, greater than a threshold (for example 20 km) for a latency less than a threshold, for example, a few minutes).

It should be noted that these various detections may be done for a drone which is piloted by a mobile network implementing this NWDAF function, but also for a drone which uses a mobile connection for transmitting a media flow (like a video flow which a drone's camera captures) and which is not necessarily controlled by a pilot connected by mobile access.

Following this step S2, in the following general step S3, these analyses allow finding the identities of each terminal (the terminal type (hardware, software supplier, etc.), the unique terminal identifier (for example IMEI type), the subscription identifier (for example IMSI type), the identity of the SIM card allowing the connection to the cellular network), which allows finding the identity of the pilot of the drone which may be in infraction (identity of subscription profile to the mobile service (ISIM), connection identity used such as IP address on the network, billing identity associated with the pilot (last name, first name, address postal code, etc.)).

It is then possible in step S4 to typically determine whether the pilot has subscribed or not to a service of the aforementioned type in agreement with civil aviation, by searching for the identity of the pilot in a declaration database generated for example in step S0. If the pilot is not identified as having subscribed to this service in step S0, an alert may be generated in step S6.

It is next possible to determine in step S5 whether the drone, even if declared in step S0, is authorized to overfly the current zone. Thus, in step S5, the terminal is identified as potentially embedded in a drone and if it is predicted that this drone is approaching a restricted flight zone by analyzing the data collected from the antennas of the mobile network, then an alert may be generated in step S6.

In step S5, for more general and automated verification of the flight zones relative to the previous authorized flight plan declarations, it can be planned that the NWDAF function verifies in the message exchanges returned by a network entity in charge of the UDM management (Unified Data Management) that an identified drone actually did have a flight authorization. Such an implementation typically serves to recover a flight identifier for the drone and an authorization level for zones which may be overflown or not.

Further, an exchange of messages between a USS entity and the NWDAF function may supply information on the planned trajectory of the drone, in order to compare it with an expected trajectory (called Expected UE Moving Trajectory) for confirmation. Thus, the NWDAF function may inform the USS entity of the area where the drone is exactly located, or even notify a third party having subscribed to a surveillance service for one of its sensitive sites that a drone was detected at in order to control its own airspace. 12.

At the outcome of this alert step S6 if consulting the USS confirms that the terminal (detected as aerial) is not authorized to be embedded in a drone, the aerial controller may decide to block the terminal by asking the mobile network to suspend connectivity with the drone. The aerial controller may declare the terminal as a drone for blocking any connection to the mobile network if there is no expected flight plan by adding the terminal to a list of terminals blacklisted with the mobile operators. The aerial controller may summon the drone operator to supply the identity of the user who used mobile connectivity in a prohibited zone, or any other action targeting the security of an airspace.

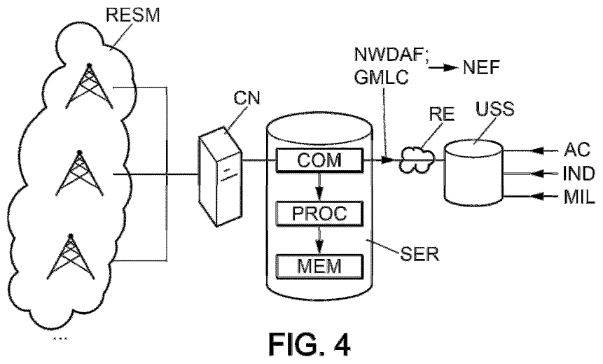

FIG. 4 shows a possible implementation of the system for implementing the method described above. The mobile network RESM is driven by an entity such that the core network CN, to which a device SER may be connected for implementing the method shown above with reference to FIG. 3. This device may for example be implemented in the form of a server SER comprising a processing circuit equipped with:
a communication interface COM (in particular with the core network CN);
a processor PROC; and
a memory MEM storing instruction data for a computer program for implementing the above method, when these instructions are read and executed by the processor PROC.

The communication interface COM of the server allows establishing a connection (for example via a wide area network RE), with a USS platform of the aforementioned type. Typically, the server SER, connecting to the core network CN, may implement NWDAF or GMLC type functions, which may address an NEF type function of the USS platform as previously described.

Of course, the USS platform may further receive data from authorities such as civil aviation AC, or even from military MIL or industrial IND authorities wishing to restrict the overflight of sensitive areas (typically military or industrial sites).

The present disclosure is not limited to the embodiments described above as examples; it extends to other variants.

Thus for example, the aforementioned server SER may be an integral part of the core network CN, which may directly execute the NWDAF and/or GMLC functions in connection with the NEF function of the USS. Thus, the device in the meaning of the present disclosure may be the core network CN, directly.

Further, the interconnection of the server SER (or directly of the core network CN) to a USS type platform is an implementation example. As a supplement or variant, the industrial or military authorities (or others) may share an interconnection server SER with the core network CN for directly receiving alerts issued from the surveillance of the network by implementing the NWDAF function in particular, typically for determining whether a drone having an embedded terminal with abnormal behavior has overflown a sensitive area (military or industrial).

Further, the steps S21 to S23 above are shown as examples concerning what execution of an NWDAF type function allows: on the other hand, another type of function such as GMLC may be implemented, as a variant or in addition to the NWDAF type function, and, on the other hand, the implementation of only one or two of these steps S21 to S23 is possible.

Further, the embedded object UE was called above by the designation “terminal”. In 3GPP terminology, the terminal may also be designated by the terms “user agent” (and still noted UE).

Further, in the step S0 shown above, during the subscription, the user may be asked whether the drone is associated with just one user (or terminal) or else a SIM/IMEI pair associated with one drone, over this flight space, as described above. Otherwise (if the user has several terminals or user agents embedded), the user provides the identifiers of the other user agents (SIM, IMEI, PEI) in order to complete the analysis over the trajectories of various user agents embedded together in one device.

1. A method implemented by an entity of a mobile network comprising a plurality of cells covered by respective antennas of the network, for detection of a terminal which could be embedded in a device in flight, where the terminal is connected to the mobile network, wherein the method comprises:
obtaining current data for connection transfer of the terminal from one cell to another cell of the mobile network, said current data comprising at least respective moments of said transfers, and data from cells involved in said transfers;
comparing the current data to terrestrial terminal connection transfer reference data and having at least one cell of said current data get involved; and
determining whether the terminal is embedded in a device in flight if the current data do not respect the reference data.

2. The method according to claim 1, wherein, two cells of the network are deemed to be adjacent if they provide a connection transfer for a terrestrial terminal from one of the two cells to the other, said data comparison comprises detection in the current data of a connection transfer between two cells which are not deemed to be adjacent.

3. The method according to claim 2, wherein the current data further comprise respective moments of said transfers, and said method comprises analyzing said current data to detect whether the terminal connects several times successively to two cells which are not deemed to be adjacent and in a time interval less than a threshold.

4. The method according to claim 2, wherein the current data further comprise respective moments of said transfers, and said method comprises analyzing said current data to detect whether a trajectory at which the terminal follows passes by successive cells which are not deemed to be adjacent.

5. The method according to claim 1, wherein the current data comprise radiofrequency connection link strength data for the terminal with each of said successive cells of the mobile network, in order to estimate successive positions of the terminal.

6. The method according to claim 1, wherein the current data further comprise respective moments of connection to said successive cells, and said method comprises analyzing said current data to determine a trajectory of the terminal and detect whether a velocity of movement of the terminal over said trajectory is greater than a threshold.

7. The method according to claim 1, wherein the method implemented by execution of an NWDAF (Network Data Analytic Function) type function.

8. The method according to claim 5, wherein the method is implemented by execution of a GMLC (Gateway Mobile Location Center) type function.

9. The method according to claim 1, wherein said current data comprise at least one identifier for the terminal and at least one user identifier for the terminal.

10. The process according to claim 9, further comprising:
consulting a platform for records of pilots and/or flight plans of devices with onboard terminals; and
determining at least whether the user identifier of the terminal is declared among said records from the platform.

11. The method according to claim 10, further comprising:
consulting said platform for determining whether at least a trajectory of the terminal conforms to a flight plan declared for said terminal.

12. The method according to claim 10, the method further comprising:
verifying whether a trajectory of the terminal includes at least one sensitive site, associated with restrictive overflight conditions.

13. A non-transitory computer readable medium comprising a computer program stored thereon comprising instructions for implementing the method according to claim 1, when the instructions are executed by a processing circuit of the entity.

14. A device connectable to a mobile network comprising a plurality of cells covered by respective antennas of the network, the device comprising:
a processing circuit configured to detect a terminal which could be embedded in a device in flight, by:
obtaining current data for connection transfer of the terminal from one cell to another cell of the mobile network, said current data comprising at least respective moments of said transfers, and data from cells involved in said transfers;
comparing the current data to terrestrial terminal connection transfer reference data and having at least one cell of said current data get involved; and
determining whether the terminal is embedded in a device in flight if the current data do not respect the reference data.

15. The device according to claim 14 comprising a connection interface, which is connectable to the mobile core network and to a platform for registration of pilots and/or flight plans for devices with onboard terminals.

16. The device according to claim 15, wherein the device is set up for executing at least one NWDAF (Network Data Analytic Function) type function, and at least one function of GMLC (Gateway Mobile Location Center) type.

17. The device according to claim 16, the device being arranged for executing said function in connection with said platform via a NEF (Network Exposition Function) type function.
